(19) United States
(12) Patent Application Publication
(10) Pub. No.: US 2013/0263412 A1
(43) Pub. Date: Oct. 10, 2013

(54) STRAP TENSIONER FOR CARGO RESTRAINING NET

(71) Applicant: Yeh-Chien Chou, Taoyuan County (TW)

(72) Inventor: Yeh-Chien Chou, Taoyuan County (TW)

(73) Assignee: Strong Yun Industrial Co., Lt

(21) Appl. No.: 13/442,891

(22) Filed: Apr. 10, 2012

(51) Int. Cl. B60P 7/00

(52) U.S. Cl. 24/68 CD

(57) ABSTRACT

The strap tensioner includes a fastener, a linking member and a ring. The fastener has a body with a first rod. The linking member has a first connecting portion and a second connecting portion. The first connecting portion is detachably fastened to the first rod. The ring has a first rail portion and a second rail portion. The first rail portion is detachably linked to the second connecting portion.

### BACKGROUND OF THE INVENTION

1. Technical Field

The invention relates to cargo transportation, particularly to cargo restraining device for vehicles.

2. Related Art

Cargo retraining nets are always used in pick-up trucks for preventing cargo from moving or jumping. A typical cargo net is essentially composed of a net, four straps separately extending four corners of the net and four strap tensioners separately linking the four straps. The connection between the strap and strap tensioner is undetachable. That means the straps and strap tensioners are integral. The net cannot be independently replaced when it is damaged. A whole cargo net with the strap tensioners must be scrapped. That is very uneconomical.

### SUMMARY OF THE INVENTION

An object of the invention is to provide a strap tensioner for cargo restraining net, which can be detached from the net. Thus the strap tensioner or net may be independently replaced.

To accomplish the above object, the strap tensioner includes a fastener, a linking member and a ring. The fastener has a body with a first rod. The linking member has a first connecting portion and a second connecting portion. The first connecting portion is detachably fastened to the first rod. The ring has a first rail portion and a second rail portion. The first rail portion is detachably linked to the second connecting portion.

### BRIEF DESCRIPTION OF THE DRAWINGS

FIG. 1 is a top plan view of a combination of the first embodiment of the invention and a cargo net;

FIG. 2 is an enlarged view of the first embodiment of the invention;

FIG. 3 is a perspective view of the first embodiment of the invention;

FIG. 4 is an exploded view of the first embodiment of the invention;

FIG. 5 is a cross-sectional view of the first embodiment of the invention;

FIG. 6 is a top plan view of a combination of the second embodiment of the invention;

FIG. 7 is an exploded view of the second embodiment of the invention; and

FIG. 8 is a cross-sectional view of the second embodiment of the invention.

### DETAILED DESCRIPTION OF THE INVENTION

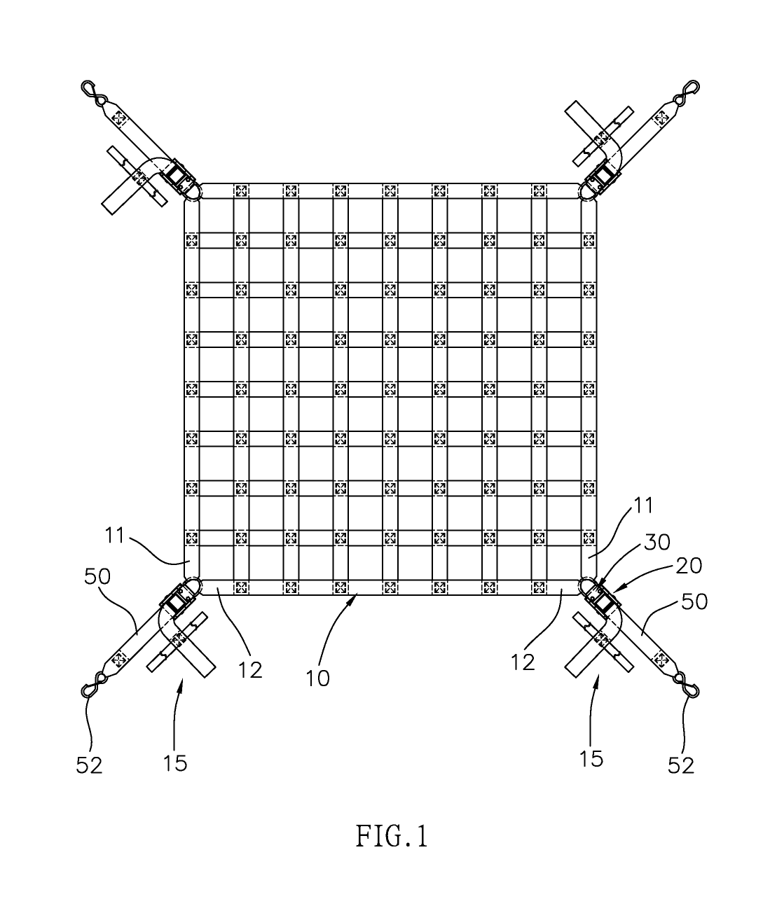

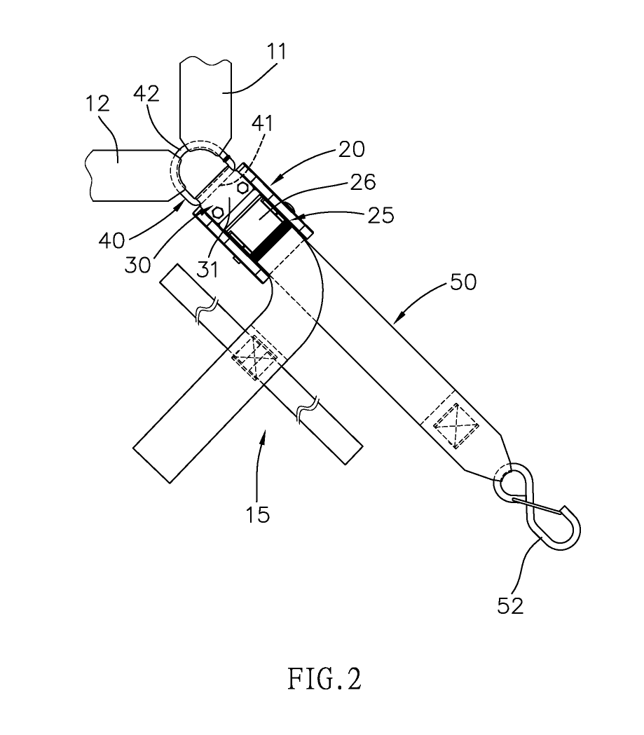

Please refer to FIGS. 1 and 2. The strap tensioner 15 of the invention is used to connect with a rectangular net 10. To connect the strap tensioner 15, each of the four corners of the net 10 has two angular straps 11, 12 which are perpendicular to each other. The strap tensioner 15 includes an anchor strap 50 for biting a vehicle body and a fastener 20 connected between the anchor strap 50 and the net 10.

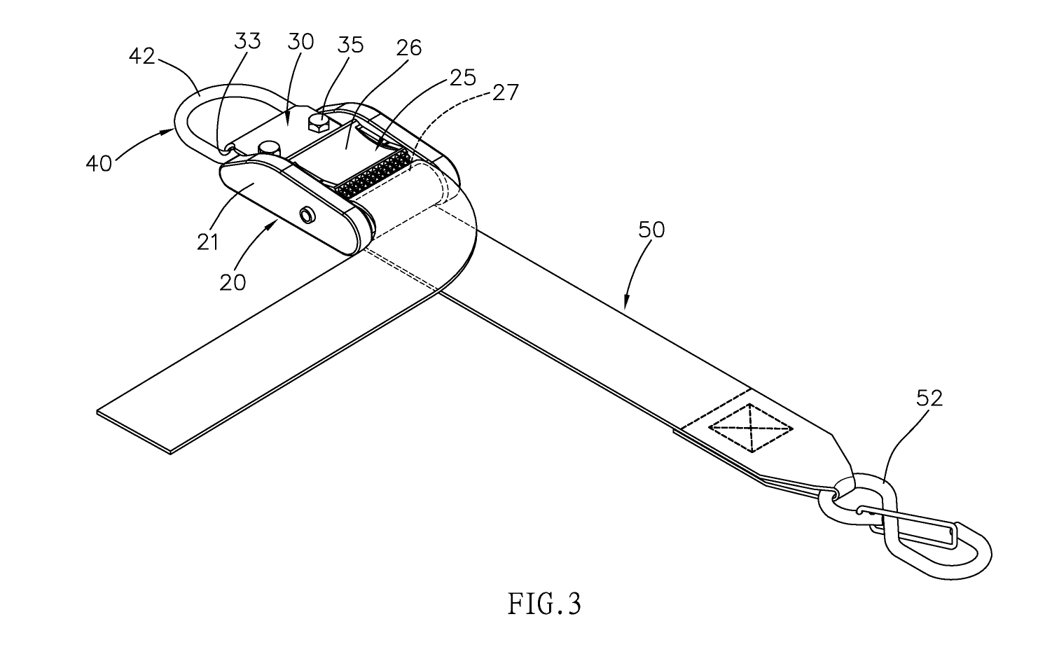

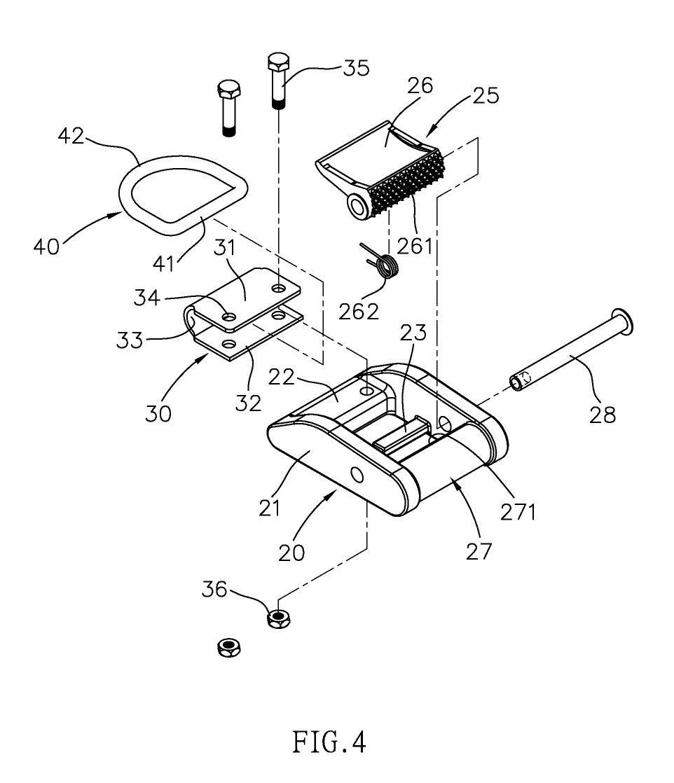

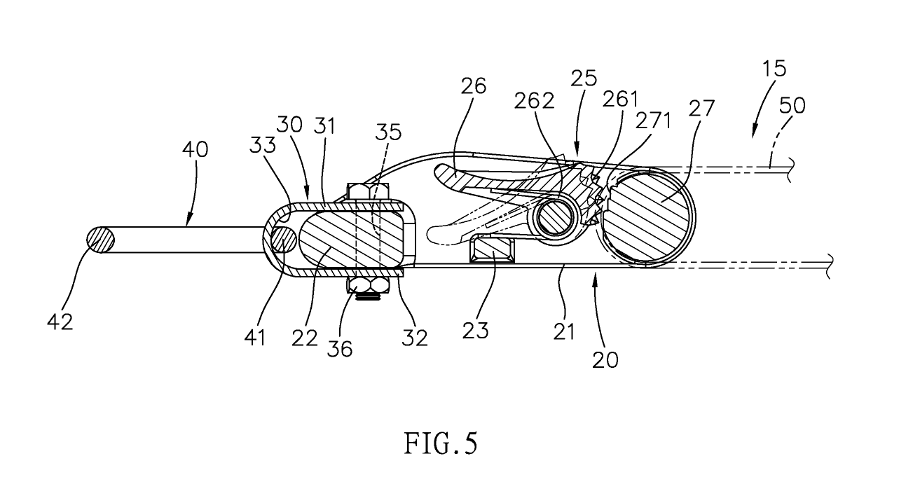

Please refer to FIGS. 3 and 4, which show the first embodiment of the invention. The fastener 20 includes a body 21, a pincher 25, a linking member 30 and a ring 40. The body 21 has a first rod 22 and a second rod 23, which are parallel to each other. The pincher 25 is composed of a stator 27, a spring 262 and a depressor 26. As shown in FIGS. 4 and 5, the depressor 26 is pivotally connected in the body 21 with a shaft 28. The spring 262 is jammed between the second rod 23 and the depressor 26. One side of the depressor 26 is formed with a first toothed surface 261 and one side of the stator 27 is formed with a second toothed surface 271 corresponding to the first toothed surface 261.

The linking member 30 includes a first connecting portion and a second connecting portion. The first connecting portion is detachably fastened to the first rod 22 and the second connecting portion is detachably linked to the ring 40. In this embodiment, the linking member 30 is a U-shaped plate, the first connecting portion is a first side 31 and second side 32, and the second connecting portion is a trough 33 between the first and second sides 31, 32. The first and second sides 31, 32 are provided with through holes 34 for being passed through by bolts 35 and nuts 36.

The ring 40 includes a first rail portion 41 and a second rail portion 42. The first rail portion 41 is received in the trough 33 and the linking member 30 pinches the first rod 22. The angular straps 11, 12 pass through the second rail portion 42 to connect the net 10 with the linking member 30 and fastener 20.

As shown in FIGS. 2 and 3, the anchor strap 50 can be firmly pinched between the first and second toothed surfaces 261, 271. A distal end of the anchor strap 50 is provided with a hook 52.

The primary feature of the invention is independent replacement of the net 10 and fasteners 20 if either of them is damaged. When the net 10 is damaged, the fasteners 20 can still be retained. The net 10 may be detached from the fasteners 20 by loosing and removing the bolts 35 and nuts 36.

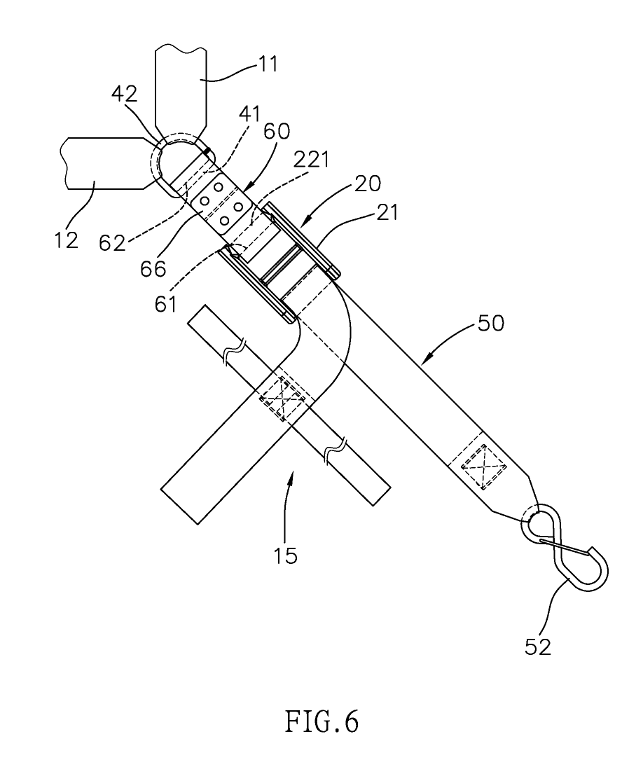

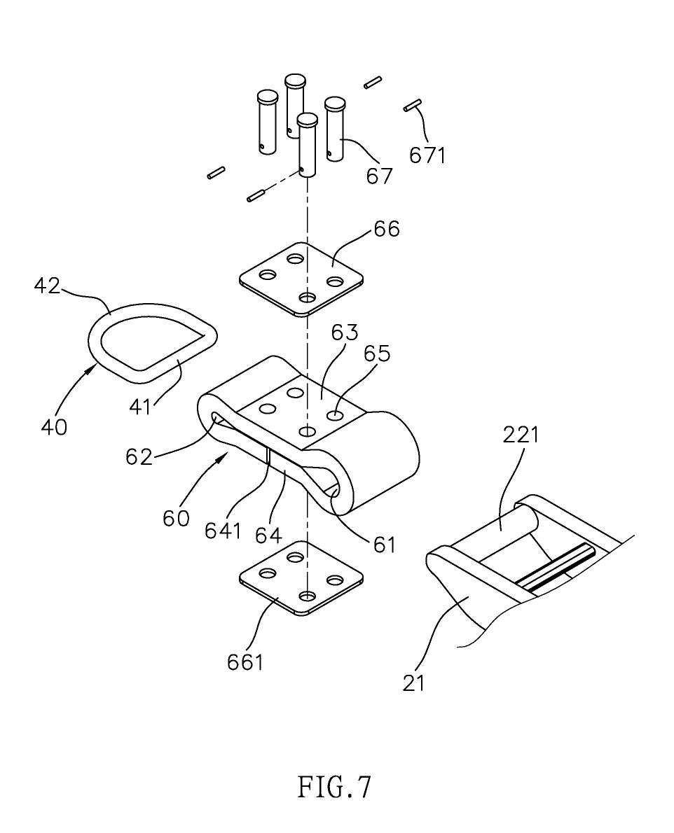

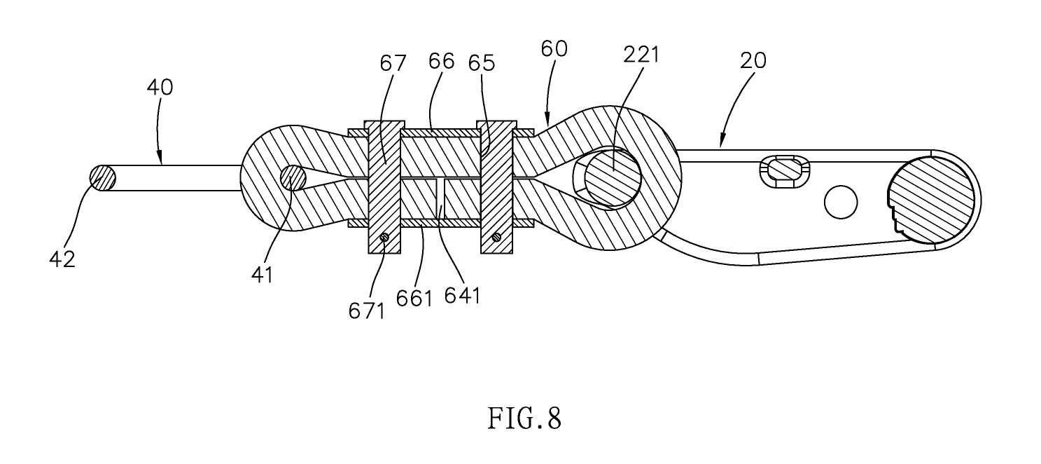

Please refer to FIGS. 6, 7 and 8, which show another embodiment of the invention. In this embodiment, the linking member 60 is a rubber belt forming a gapped ring. Two ends of the linking member 60 are the first and second connecting portions. A first channel 61 and a second channel 62 are separately formed in two ends of the linking member 60. A first side portion 63 abuts against a second side portion 64 and a gap 641 is formed in the second side portion 64. The first and second side portions 63, 64 are provided with passing holes 65. Two auxiliary boards 66, 661 with holes separately abut against the first and second side portions 63, 64. The linking member 60 and auxiliary boards 66, 661 are penetrated by inserts 67 with pins 671.

The linking member 60 can link the ring 40 and fastener 20. The ring 40 and fastener 20 can pass the gap 641 to enter the second channel 62 and the first channel 61.

As the abovementioned first embodiment of the invention, the ring 40 and the fastener 20 can be disconnected by releasing the linking member 60. Release of the linking member 60 can be performed by removing the inserts 67 and pins 671. The auxiliary boards 66, 661 can ensure the gap 641 will not be opened.

Those skilled in the art will appreciate that numerous changes and modifications can be made to the preferred embodiments of the invention, and that such changes and modifications can be made without departing from the spirit of the invention.

What is claimed is:

1. A strap tensioner for a cargo restraining net, comprising:
a fastener having a body with a first rod;
a linking member, having a first connecting portion and a second connecting portion, and the first connecting portion being detachably fastened to the first rod; and
a ring, having a first rail portion and a second rail portion, and the first rail portion being detachably linked to the second connecting portion.

2. The strap tensioner of claim 1, wherein the body has a first rod and a second rod parallel thereto, and a pincher is disposed in the body.

3. The strap tensioner of claim 2, wherein the pincher comprises a stator, a spring and a depressor, the depressor is pivotally connected in the body with a shaft, the spring is jammed between the second rod and the depressor, the depressor is formed with a first toothed surface and the stator is formed with a second toothed surface corresponding to the first toothed surface.

4. The strap tensioner of claim 1, wherein the linking member is a U-shaped plate, the first connecting portion is a first side and second side, the second connecting portion is a trough between the first and second sides, the first and second sides are provided with through holes for being passed through by bolts.

5. The strap tensioner of claim 1, wherein the linking member is a rubber belt forming a gapped ring, two ends of the linking member are the first and second connecting portions, a first channel and a second channel are separately formed in two ends of the linking member, a first side portion abuts against a second side portion and a gap is formed in the second side portion, the first and second side portions are provided with passing holes, two auxiliary boards with holes separately abut against the first and second side portions, and the linking member and the auxiliary boards are penetrated by inserts.

6. The strap tensioner of claim 5, wherein each of the inserts is penetrated by a pin to fasten the auxiliary boards and the linking member.
